(19) United States
(12) Patent Application Publication
(10) Pub. No.: US 2004/0122793 A1
(43) Pub. Date: Jun. 24, 2004

(54) Dynamic generation of disk configuration from XML model

(76) Inventors: John C. Mese, Cary, NC (US); Nathan J. Peterson, Raleigh, NC (US); Rod David Waltermann, Rougemont, NC (US)

Correspondence Address: IBM CORPORATION, Personal Systems Group, Intellectual Property Law, Dept. 9CCA/002-2, P.O. Box 12195, Research Triangle Park, NC, 27709-2195, US

(21) Appl. No.: 10/324,889

(22) Filed: Dec. 20, 2002

(51) Int. Cl. G06F 7/00

(52) U.S. Cl. 707/1

(57) ABSTRACT

A method and system is disclosed for configuring hardfiles of a computer system during original installation on a manufacturing line, reinstallation of the system, or any time a hardfile requires configuration. The method for configuring a hardfile for a computing system includes the steps of: a) abstracting drive configuration parameters into one or more text instructions using a standard generalized markup language; b) creating a model of a virtual hardfile in a memory from the one or more text instructions; and c) generating one or more physical drive configuration scripts to recreate the model in the hardfile.

### FIELD OF THE INVENTION

The present invention relates generally to computer manufacturing and more specifically to configuring hardfiles during original installation on a manufacturing line, reinstallation of the system, or any time a hardfile requires configuration of a computer system during original installation on a manufacturing line.

### BACKGROUND OF THE INVENTION

Current computer manufacturing processes use an assembly line to construct, configure, test and ship computer systems. Additionally, this method is applicable during reinstallation of the system or any time a hardfile requires configuration. Virtually every computer system manufactured today includes one or more hardfiles (e.g., hard drive) for non-volatile storage of programs and data. Installing drive configuration parameters onto the computer systems, typically by use of custom script files, configures these hardfiles. The script files are usually customized to a particular computer system, hardfile, installed application suite and anticipated use of the computer system. Any changes to the configuration require manual changes to potentially several script files. Since the scripts are predefined for a particular use, changing the script file can be tedious and prone to any of several possible errors. These errors include misconfigurations based upon insufficient skill in editing or installing the one or more scripts or even simple typographic errors in transcribing the script(s).

It would be desirable to be able to simply and easily provide a method and system for preloading drive configuration information (e.g., size, order, etc.) so that the system would allow for simply, efficiently and accurately changing the configuration so that the configuration is correct, any dependencies between partitions/drives are automatically assessed and implemented, and correct script files may be generated dynamically for any possible configuration.

Accordingly, what is needed is a method and system for configuring hardfiles of a computer system during original installation on a manufacturing line. The present invention addresses such a need.

### SUMMARY OF THE INVENTION

A method and system is disclosed for configuring hardfiles of a computer system during original installation on a manufacturing line, reinstallation of the system, or any time a hardfile requires configuration. The method for configuring a hardfile for a computing system includes the steps of: a) abstracting drive configuration parameters, from the desired configuration, into one or more text instructions using a standard generalized markup language; b) creating a model of a virtual hardfile in a memory from the one or more text instructions; and c) generating one or more physical drive configuration scripts to recreate the model in the hardfile which matches the desired configuration.

The present invention permits efficient changes to hardfile configuration so that the configuration is correct, any dependencies between partitions/drives are automatically assessed and implemented, and correct script files are generated dynamically for any possible configuration.

### BRIEF DESCRIPTION OF THE DRAWINGS

FIG. 1 is a flowchart of the preferred embodiment for a hardfile configuring process;

FIG. 2 is a flowchart of the preferred embodiment for the abstraction process shown in FIG. 1;

FIG. 3 is a flowchart of the preferred embodiment for the model resolution process shown in FIG. 1; and

FIG. 4 is a flowchart of the preferred embodiment for the script generation process shown in FIG. 1.

### DETAILED DESCRIPTION

The present invention relates to computer manufacturing, reinstallation of the system, or any time a hardfile requires configuration and more specifically to configuring hardfiles of a computer system during original installation on a manufacturing line. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

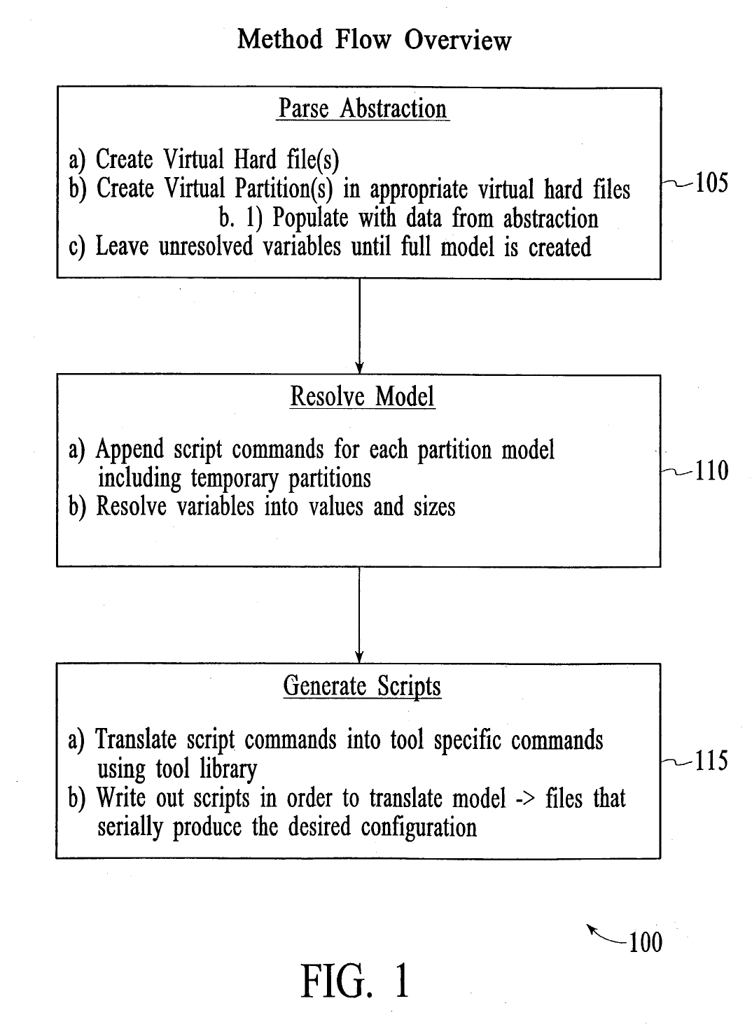

FIG. 1 is a flowchart of the preferred embodiment for a hardfile configuring process 100. Configuring process 100 includes three steps: (1) parsing an abstraction (step 105), (2) resolving a model of a virtual hardfile (step 110), and (3) generating one or more configuration scripts (step 115). A desirable hardfile configuration is abstracted into a standard generalized markup language (SGML), for example extensible markup language (XML), to create an XML abstraction preliminarily to process 100. The abstraction is a textual representation of the desired configuration for the one or more hardfiles to be configured.

Parsing step 105 includes creating one or more virtual hardfiles, creating one or more virtual partitions in the appropriate one or more virtual hardfiles (that will be populated with data from the abstraction), and leaving unresolved or unresolvable variables until creation of a full model.

Resolving step 110 includes appending script commands for each partition model, including temporary partitions, and resolving variables into values and sizes.

Generating step 115 includes translating script commands into tool specific commands using a tool library and writing out the commands in order to translate the model. These commands serially produce the desired physical hardfile configuration.

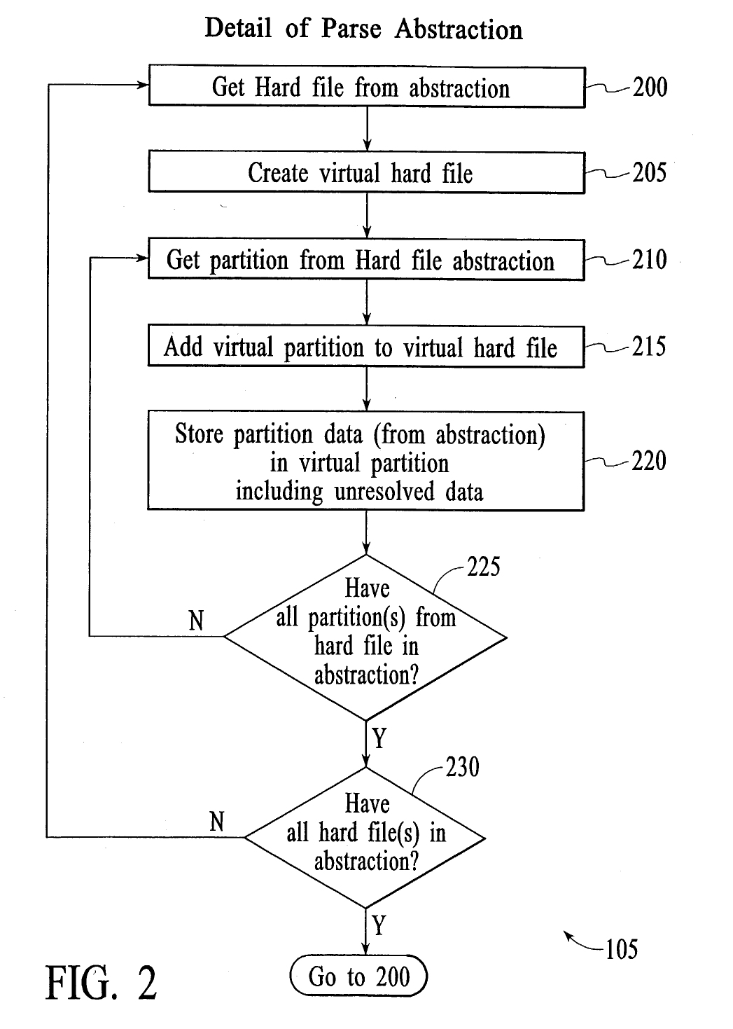

FIG. 2 is a flowchart of the preferred embodiment for the parsing abstraction process 105 shown in FIG. 1. The preferred embodiment uses XML, therefore the following description will be made using the more specific type of SGML with the understanding that other types of markup languages or other representative languages, both public or proprietary, may be used instead of XML.

The XML model simplifies modifications to altering text properties for several reasons, including that the alterations may be done programmatically or could be generated automatically. Additionally, as XML it also provides a standard for exchanging data. Process 100, for each hardfile, creates a virtual partition in the virtual hardfile and appends commands to create and select the correct location of the partition on the hardfile.

The following is a sample except of such an XML abstraction:

```
<hardfile sequenceNumber=“1”>
    <primaryPartition label=“PRELOAD” location=“1” sizeRelative=
    “fixed” sizeFixed=“100” sizeFixedUnits=“percent”>
        <!-- ...software installation packages go here... -->
        </primaryPartition>
        <primaryPartition label=“DATA” location=“2” sizeRelative=
        “scaled” sizeScaledBuffer=“200”
    sizeScaledBufferUnits=“MB”>
        <!-- ...software installation packages go here... -->
        </primaryPartition>
    </hardfile>
```

The above XML shows two partitions, each with a unique label. The XML specifies that the first primary partition is to be placed in the first entry in the partition table and it is to have a fixed size of 100 percent. The XML specifies that the second partition is to be placed in the second entry in the partition table and that it is to have a scaled size, meaning the amount of space required by the contents of that partition (denoted by the commented ellipse), plus a 200-megabyte buffer. The first partition then receives 100 percent of the free space of the hardfile less the space needed by the second partition plus the indicated 200-megabyte buffer. Note: when the XML specifies that a partition is to be placed in a latter partition table entry, scripts are generated to create and destroy temporary intermediary partitions.

Parsing step 105 analyzes the XML abstraction and selects an unprocessed hardfile for processing (step 200). The XML abstraction may contain configuration information for one or more hardfiles, and the preferred embodiment processes each hardfile individually. After step 200, parsing step 105 next creates a virtual hardfile at step 205, and selects an unprocessed partition for the hardfile from the XML abstraction (step 210). Parsing step 105 next adds a corresponding virtual partition to the virtual hardfile (step 215) and stores partition data (from the XML abstraction) in the virtual partition (including unresolved/unresolvable data) at step 220. The unresolved/unresolvable data refers to variables or data that are dependent upon other factors and is not or cannot be resolved at this parsing step 105. Parsing step 105 tests to determine whether all partitions for the hardfile have been processed at step 225. If one or more unprocessed partitions remain for the current hardfile, parsing process 105 branches to step 210 to process step 210 through step 225 for each remaining partition. When all partitions for the hardfile have been processed, parsing step 105 advances to step 230 to test whether all hardfiles have been processed. If one or more hardfiles are unprocessed at step 230, parsing step 105 returns to step 200 to process step 200 through step 225 for each remaining hardfile. Once all hardfiles have been processed, parsing step 105 is complete and process 100 advances to model resolution step 110.

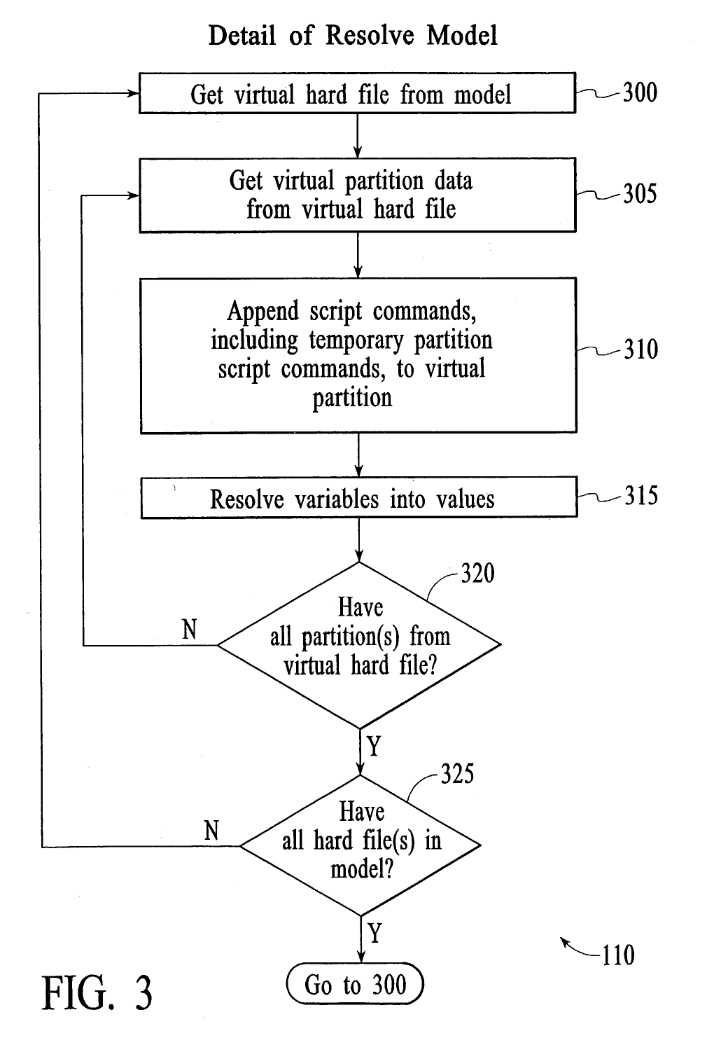

FIG. 3 is a flowchart of the preferred embodiment for the model resolution process 110 shown in FIG. 1. A drive configuration engine parses through the XML abstraction to resolve dynamically the necessary hardfile configuration. After all partitions have been processed, step 110 examines the script in each virtual partition and resolves the remaining size variables since all unknowns have been recorded in the virtual hardfile model.

Specifically, process 110 starts at step 300 and obtains an unprocessed virtual hardfile from the virtual model created by the abstraction parsing step 105 as discussed above. Process 110 next (step 305) obtains data for a virtual partition for the hardfile obtained in step 300. Process 110 next (step 310) appends script commands including temporary partition script commands to the obtained virtual partition and resolves (step 315) variables into values. Process 110 next tests whether all virtual partitions for the hardfile have been processed at step 320. If one or more virtual partitions have been unprocessed, process 110 returns to step 305 to repeat step 305 through 315 for each unprocessed virtual partition for the hardfile. Once all virtual partitions have been processed, process 110 advances to step 325 from step 320 to test whether all hardfiles have been processed. If one or more virtual hardfiles have been unprocessed, process 110 returns to step 300 to repeat step 300 through 320 for each unprocessed virtual hardfile. Once all virtual hardfiles have been processed, process 110 is complete and advances to script generation step 115.

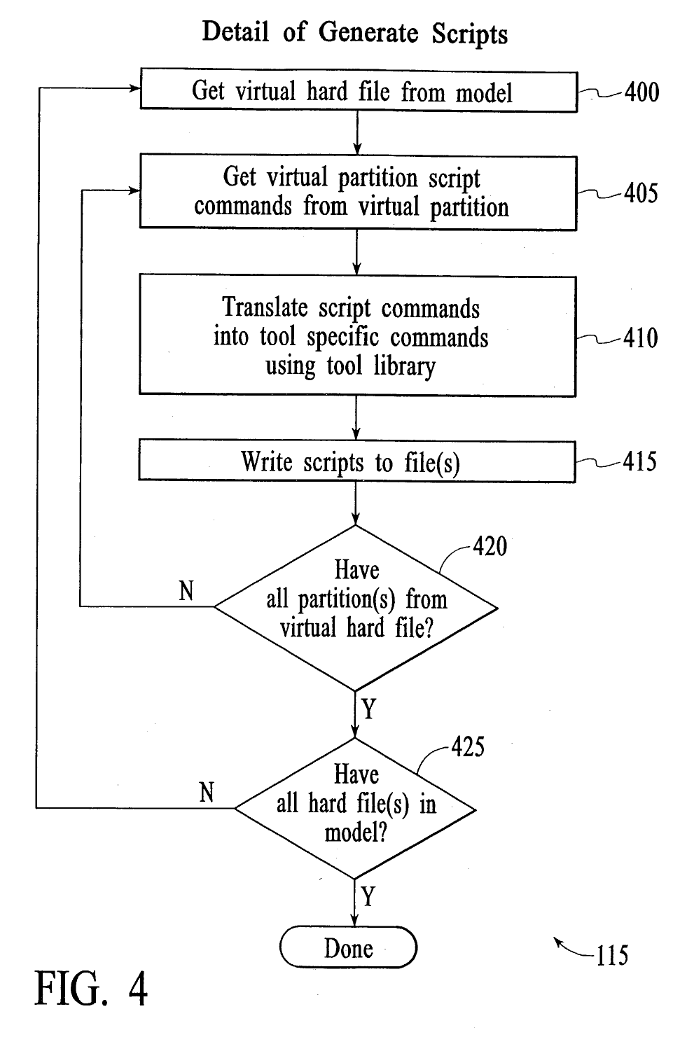

During step 115, the necessary physical hardfile configuration scripts are generated. FIG. 4 is a flowchart of the preferred embodiment for the script generation process 115 shown in FIG. 1. After resolving the necessary hardfile configurations, process 115 determines an appropriate tool to use with the configuration engine. The configuration engine assembles the appropriate script commands for the appropriate tool. Process 115 writes the scripts from the virtual partitions out to files in the correct order such that sequential execution creates the desired drive as specified in the XML.

Specifically, script generation process 115 obtains, at step 400, an unprocessed hardfile from the resolved model produced by model resolution step 110 as explained above. Process 115 next, step 405, gets virtual partition script commands from an unprocessed virtual partition for the virtual hardfile that was obtained at step 400. Process 115 thereafter translates the script commands into tool-specific commands at step 410, and writes scripts to one or more files (step 415). Thereafter, process 115 tests whether any unprocessed partitions remain at step 420. If one or more partitions for the virtual hardfile remain unprocessed, process 115 returns to step 405 to repeat step 405 through 420 until all partitions have been processed. Thereafter, process 115 advances to step 425 once all partitions for the hardfile have been processed to test whether any hardfiles remain unprocessed. If one or more hardfiles in the model are unprocessed, process 115 returns to step 400 to select an unprocessed hardfile and to repeat step 400 through step 420 for each partition of the new unprocessed hardfile. Once all hardfiles have been processed, process 115 is complete. The files containing the tool scripts are thereafter available for use in physically configuring physical hardfiles as specified in the abstraction.

An example of the generated scripts:

SELECT DRIVE 1

SELECT PARTITION 1

RESIZE IMAGE 7541

RESTORE IMAGE

and

SELECT DRIVE 1

SELECT PARTITION 2

RESIZE IMAGE 651

RESTORE IMAGE

Since the script files are generated dynamically, changes in the size of one partition as specified in the XML, for example, will be automatically accounted for at runtime and will generate correct scripts. This is significant in the example above because the size of the first primaryPartition is dependent on the size of the second. In the example above, the sizes are determined, in this example, as follows: 7541 MB+(451 MB+200 MB)=8192 MB (the size of the drive).

In the example above, the scripts are fairly simple because the partitions are laid down in order. However, to accommodate gaps between partitions for free space and/or strictly enforcing the location of partitions on the physical drive, more complex scripts can be generated. Specifically, several intermediary partitions are created and then destroyed in order to create gaps and/or create a partition in a particular spot on the drive.

Modifications resulting from these creations/deletions are also stored in the virtual hardfile model. The resulting scripts from the model will produce the desired end configuration when executed serially.

There are many different imaging tools available for physically configuring a hardfile from such predefined scripts. Some of these tools include partitioning tools available from Powerquest (PowerQuest, Inc., 1359 North Research Way, Bldg. K, PO Box 1911, Orem, Utah 84059-1911) or Symantec (World Headquarters, Symantec Corporation, 20330 Stevens Creek Blvd., Cupertino, Calif. 95014).

The configuration engine generates an appropriate script for the particular imaging tool to achieve the desired configuration with a physical hardfile as represented by the virtual hardfile in the memory. The configuration engine uses a library of predefined script commands to generate the dynamic, custom script necessary to achieve the desired physical configuration with the desired imaging tool. The configuration engine is modular so any imaging tool is useable with the present invention provided an appropriate library for the script commands is created. Process 100 is performed for each hardfile to be configured.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for configuring a hardfile for a computing system, comprising the steps of:
a) abstracting drive configuration parameters into one or more text instructions using a standard generalized markup language;
b) creating a model of a virtual hardfile in a memory from the one or more text instructions; and
c) generating one or more physical drive configuration scripts to recreate the model in the hardfile.

2. The method of claim 1 wherein the script generation step c) further comprises parsing the one or more text instructions to resolve dynamically hardware configuration of the hardfile.

3. The method of claim 1 wherein the hardfile includes one or more partitions, and wherein the model creating step b) includes the step of b1) creating each virtual partition in the virtual hardfile.

4. The method of claim 3 wherein the generated scripts create and destroy a temporary partition.

5. The method of claim 4 wherein the temporary partition separates two installed partitions.

6. The method of claim 4 wherein the temporary partition spaces a second partition at a desired location on the hardfile.

7. The method of claim 1 wherein the generating step c) uses predefined libraries for an arbitrary hardfile imaging tool.

8. A system for configuring a hardfile for a computing system, comprising:
means for abstracting drive configuration parameters into one or more text instructions using a standard generalized markup language;
means for creating a model of a virtual hardfile in a memory from the one or more text instructions; and
means for generating one or more physical drive configuration scripts to recreate the model in the hardfile.
